(19) United States
(12) Patent Application Publication
(10) Pub. No.: US 2007/0130101 A1
(43) Pub. Date: Jun. 7, 2007

(54) Method and system for granting access to personal information

(76) Inventors: Terry Paul Anderson, Minneapolis, MN (US); Gregory Jay Sharp, Toronto (CA)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/588,569

(22) Filed: Oct. 26, 2006

Related U.S. Application Data
(60) Provisional application No. 60/730,756, filed on Oct. 26, 2005.

(51) Int. Cl. G06F 17/30; G06F 7/00

(52) U.S. Cl. 707/1

(57) ABSTRACT

A system and method to permit users to have personal unique identifiers associated with personal information stored on a database accessed by an identity server is disclosed. The identity server is connected to one or more networks including the Internet. Users can distribute the personal unique identifier to third parties who can then obtain the personal information by accessing the server through the network. The users may modify the information stored in the database, which can then assist third parties in obtaining the modified information by inputting the personal unique identifier, or permitting client software to do so automatically on their behalf, in turn making updates to that information for the third party. This can be done over a large period of time such that third parties can easily access personal information of the user even if that information changes. The third parties may also be organizations or corporations with extensive customer lists that wish to update their client contact information with minimum interference to the customers and at minimal costs to the organization. Furthermore, users can use the personal unique identifier to populate electronic forms, such as web forms, provided on web sites hosted by organization or corporation, for the convenience of the organization or corporation and the use. The personal information of the user may also be organized in different cards having a variety of reveal and hidden status levels permitting access to additional information if a key, comprising an alphanumeric code, is entered together with the unique identifier.

### CROSS-REFERENCE TO RELATED APPLICATIONS

This application claims priority from U.S. Provisional Patent Application No. 60/730,756, filed on Oct. 26, 2005, which is incorporated herein by reference in its entirety.

### FIELD OF THE INVENTION

This invention relates to a method and system for granting access to personal information. In particular, this invention relates to a system and method for granting access to personal information using unique identifiers given by users to third parties. This invention also relates to a system and method facilitating updating of personal information.

### BACKGROUND OF THE INVENTION

In our increasingly mobile culture, organizations face the challenge of staying in touch with clients and customers as they move from job to job, city to city and country to country. Individuals face a similar challenge as they try to stay in touch with both friends, family and work colleagues. E-mail addresses, telephone numbers and physical “brick and mortar” addresses change frequently, but there is often no permanent, unchanging element of information.

In addition to movement, there are numerous examples of how these constant changes cause inconvenience, expense and require valuable time to manage, both on the part of the person who is moving and on the part of the organization or individual who is attempting to contact the person who has moved. For instance, if you need a cell phone number for a work colleague, there generally is no such “directory assistance” which can provide cell phone numbers thereby preventing quickly locating their number. Furthermore, while several people submit their contact information to organizations, the information can quickly become outdated. Furthermore, several individuals pass out business cards, the business cards may be old and/or the information contained on the business cards may be out of date. Furthermore, many people may have changed jobs, been promoted to new positions, updated their e-mail addresses, or changed their mobile phone numbers in the interim since submitting their information to an organization or handing out a business card. Furthermore, some jurisdictions have changed their telephone area codes or even changed the number of digits in the telephone numbers to accommodate the increasing number of telephones, cell phones and facsimile machines in any given area. There would be no easy way to reconnect with these people if one or more of their contact information has changed.

Several organizations often lose touch with clients once they have changed their circumstances, such as moved on from college, or moved from one city to another city. Furthermore, several people often lose touch with friends under similar circumstances. It is often difficult to find and reconnect with such individuals. This is compounded by the fact that several people may change their names, as may result, for instance, from marriage or divorce.

Furthermore, over time people become associated with a growing number of organizations, including e-commerce web sites, print subscriptions, associations, banks and utilities. Each organization holds a stagnant version of a client's contact information, and each will require a manual update by the client when the information changes. Not only is the task becoming increasingly burdensome for the information owner, because the sheer number of locations (especially online) makes the task almost impossible to manage effectively, the task of an organization managing and updating valuable customer data becomes more costly to do.

Furthermore, individuals are represented by a growing number of contact information elements, particularly in the digital realm; today alone a single person could have IDs in multiple instant messenger services, a personal web page, an internet voice account, online IDs in numerous social networking sites, and multiple email addresses. The task of keeping all this data current in all locations is near impossible to manage.

Furthermore, as people's lives change, or as organizations change values or offerings, people need control over the type and frequency of communications they wish to receive from organizations; for example, marketing material. With personal contact information distributed through multiple locations, there is no centralized way to monitor and control use of one's contact information, for the purposes of communication by organizations.

Furthermore, organizations eager to acquire and retain customers have a significant cost of customer contact information management. Statistics show that 15% of physical addresses change each year, as do 30% of online IDs, such as email addresses. Loss of contact due to outdated information is a significant cost to organizations.

Furthermore, while friends and colleagues may send e-mails advising you that their contact information has changed, in our increasingly busy lifestyles, such e-mails may be ignored or misplaced or diverted by SPAM filters or could be lost through a system failure or virus.

Furthermore, even in cases where people can store information, such as in an address book, access to this type of storage medium is not always accessible, particularly when travelling.

While it is often possible for people to contact friends, family or colleagues by one medium, such as a telephone number, or another piece of contact information such as an e-mail address, this can generally be time-consuming and difficult to do. Furthermore, if the reason for the contact information being required is for an invitation, congratulatory card or birthday card, it is often embarrassing to request this contact information in order to forward these types of items.

Accordingly, there is a need for a more effective system and method for people to be able to share contact information with organizations, friends and/or colleagues which is efficient for both the recipient party and the party whose personal contact information is being given. Furthermore, there is a need in the marketplace for a system and method which permits individuals to be uniquely identified by a means which remains stable in our mobile culture when physical addresses, e-mail addresses, online IDs, telephone numbers and, in some cases, even personal names can change over time. Furthermore, there is a need in the marketplace to be able to share different types of information, such as personal information, work-related information, billing-related information, shipping-related information, school-related information and/or family-related information with different organizations or individuals and limit the nature and use of the personal information being shared, depending on the recipient parties.

### SUMMARY OF THE INVENTION

Accordingly, it is an object of this invention to at least partially overcome some of the disadvantages of the prior art. Also, it is an object of this invention to provide an improved type of system and method which provides a network-based or a web-based service for users to share contact information with others. Furthermore, it is an object of this invention to provide an improved type of system and method for providing contact information which can be modified easily and seamlessly to the recipient of the information. Furthermore, it is an object of this invention to provide a system and method to segregate and govern use of contact information by different categories of recipients.

Accordingly, in one aspect, the present invention resides in a web-based service which provides a simple and safe way to ensure that third parties always have access to a user's current contact information. In such a system, a user would choose a unique name or unique personal identifier for themselves, and enter all current contact information in a database associated with that unique user name or unique personal identifier. Such access to the database may be performed, in a preferred embodiment, through a website accessed through the Internet. The user may then share the unique personal identifier with others, by any means available, such as via e-mail, in an advertisement, in a meeting, at a party, or printed on business cards, or submitting through electronic form including in a web form. Any third party or “guest” having the unique personal identifier can request the current contact information for that individual by accessing the database, such as by a website through the Internet, and obtaining the personal information associated with the unique identifier. The user name provides a unique personal identifier which is independent to the user's other contact information, including the user's personal name. In this way, the personal unique identifier could be used by the user to assist the user to maintain and share contact information with others for as long as the unique personal identifier is active. The personal unique identifier could also be used by guests and other users to obtain information about the user and which the user desires to reveal to the public and/or specific guests.

The users, in one embodiment, have full control over what specific information they can share with any particular requesting party. Such access may be increased, for instance, by way of a key identifier, which, in one embodiment, is an alphanumeric code, associated with the personal unique identifier. For instance, accessing the database, such as through the website, using both the personal unique identifier and a key associated with the unique identifier may reveal hidden information which otherwise would not be revealed by accessing the database with the personal unique identifier alone.

To access the network, a device, such as a personal digital assistant (“PDA”), or a cell phone, as well as server computer or personal computers, may be used. Furthermore, such a connection may be through a wired connection or a wireless connection as is known in the art. In addition, client software and interfaces modules for these devices including PDA's, personal computers and servers, may be available to facilitate access to the database containing the personal information and the unique user names or identifiers. In this way, any user or guests can easily enter or submit a stored version of the user name for an individual and obtain the personal contact information which is available for that user.

In one aspect of the invention, the personal contact information is kept private and the user has total control over the nature of the personal contact information which is revealed and to whom that information is revealed by controlling access to that data.

In one aspect, the present invention resides in a method for granting access to personal information comprising: selecting a personal unique identifier to uniquely identify a user in an identity database; storing personal information regarding the user in the identity database associated with the personal unique identifier; providing the personal unique identifier to at least one other person, including an organization or individual, said at least one other person submitting the personal unique identifier into the database to retrieve said personal information for the user.

In a further aspect, the present invention resides in a method for facilitating access to personal information comprising: selecting a personal unique identifier to uniquely identify a user in an identity database controlled by a personal unique identifier server; storing personal information regarding the user in the identity database associated with the personal identifier; accessing the personal unique identifier server by the user inputting the personal unique identifier and a further password identifier through a network to permit the user to modify the personal information; providing the unique identifier to at least one other person, including an organization or individual; wherein the at least one other person can submit the unique identifier to access the personal information associated with the unique identifier, said personal information reflecting modifications made by the user.

In a still further aspect, the present invention provides a system for controlling access to personal information, said system comprising: a database containing a plurality of personal unique identifiers, each personal unique identifier uniquely identifying personal information of a particular user associated with the corresponding unique personal identifier; a personal unique identifier server for providing access to the personal information stored in the database; wherein the user can provide their personal unique identifier to at least one person, other than the user, such that said at least one other person can access the personal information of the user associated with the unique personal identifier through the personal unique identifier server.

In a still further aspect, the present invention resides in a method for granting access to personal information comprising: selecting a personal unique identifier to uniquely identify a user in an identity database; storing personal information regarding the user in the identity database associated with the personal unique identifier; submitting the personal unique identifier to a web form offered on a web site to accept and store personal information, said web site operating an interface module capable of passing the given personal unique identifier into the identity database to retrieve said personal information on the user's behalf, and then populating the web with the personal information.

Further aspects of the invention will become apparent upon reading the following detailed description and drawings, which illustrate the invention and preferred embodiments of the invention.

### BRIEF DESCRIPTION OF THE DRAWINGS

In the drawings, which illustrate embodiments of the invention:

FIG. 1 illustrates a symbolic representation of a system which may be used in the present invention;

FIG. 2 illustrates a schematic representation of the function of the server and accessing data stored in the database according to one embodiment of this invention;

FIG. 3 illustrates a representation of the personal information stored for a particular user according to one embodiment of the present invention;

FIG. 4 is a schematic representation illustrating the function of a remote client web site accessing data stored in the database according to one preferred embodiment of this invention;

FIG. 4a illustrates population of information on a web form by a remote client web site according to one aspect of the present invention; and

FIG. 5 is a schematic representation illustrating updating of personal information contained by a remote client according to a further preferred embodiment.

### DETAILED DESCRIPTION OF THE PREFERRED EMBODIMENTS

Preferred embodiments of the invention and its advantages can be understood by referring to the present drawings. In the present drawings, like numerals are used for like and corresponding parts of the accompanying drawings.

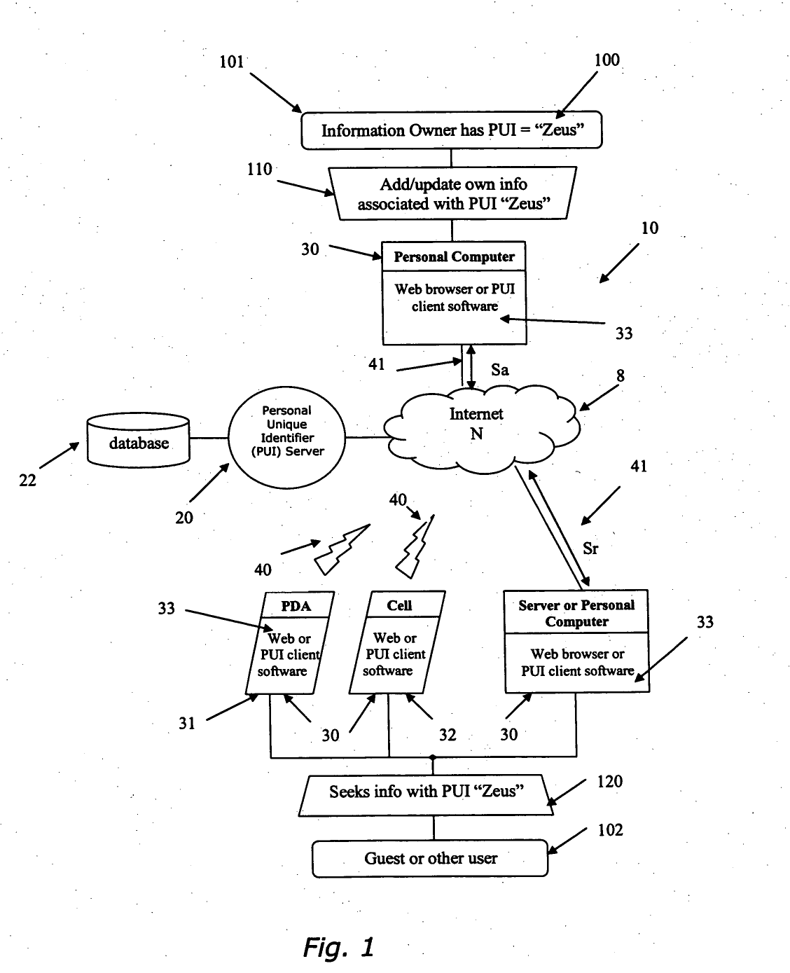

As shown in FIG. 1, one embodiment of the present invention relates to a system, shown generally by reference numeral 10, comprising a personal unique identifier (“PUI”) server 20 connected to a personal information database 22. The database 22 is connected through the PUI server 20 to a network, represented generally by reference numeral N. In a preferred embodiment, the network N comprises the Internet 8. It is understood that the database 22 may form part of the PUI server 20 or be physically separate.

A plurality of users and guests (where users can be individuals or organizations) may access the database 22 through the PUI server 20 by means of a number of various devices 30 for accessing the PUI server 20 through the network. These devices 30 may comprise personal digital assistants (“PDAs”) 31, which can be any type of electronic hand-held information devices, as well as cell phones 32. Such PDAs 31 and cell phones 32 may access the database 22 through the PUI server 20 by means of a wireless connection, shown generally by reference numeral 40, and/or a wired or land connection 41 and through a number of networks including the Internet 8. As is also illustrated in FIG. 1, the devices 30 may also comprise a web browser or other software such as client software or interface module operating on a computer or other type of digital device, shown generally by reference numeral 33, which facilitates access to the database 22 through the PUI server 20. The devices 30 can send and receive information, including personal data, to and from the database 22 as discussed more fully below.

As illustrated in FIG. 1, a user 101 may have a personal unique identifier 100 which, for illustration purposes only, comprises the word “Zeus.” It is understood that the personal unique identifier 100, in this case the word “Zeus,” could be used by a user 101 to identify him or herself. Furthermore, it is understood that the personal unique identifier 100 is not restricted to identifying an individual person, but could be used to identify a group of people, an organization, a corporation, a government agency or any other entity. The word “Zeus” would be associated with corresponding personal contact information for the user 101 in the database 22, which will be discussed in more detail below.

Other persons may access the personal contact information of the user by inputting the unique identifier 100, in this case the word “Zeus” into the database 22. For instance, any other persons also referred to as guests, and shown generally by reference number 102, may input the user name “Zeus” through the Internet 8 using the client software and/or the web browser 33 to access the PUI server 20 either through a website or other interface. The guest 102 may then access the personal information, including contact information, which the user 101 associated with the personal unique identifier “Zeus” has made available for view in association with the personal unique identifier “Zeus.”

As illustrated in FIG. 1, the user 101 may update or add information associated with the user's personal unique identifier 100, which, in this example, is the word “Zeus.” This can be done, for instance, by the user 101 sending add/update signals Sa. The add/update signals Sa may be sent by any manner, as discussed above, to the personal unique identifier PUI server 20 and the database 22. For instance, this may be done, as illustrated in FIG. 1, by means of the wired or land connection, shown generally by reference numeral 41, and via a web browser/or client software 33 accessing the Internet. It is understood that the personal unique identifier PUI server 20 may also be accessible through a web page, which preferably has security features, and can be accessed through the Internet N. Similarly, a guest 102 may send search and retrieve signals Sr to and from the personal unique identifier PUI server 20 to access the information stored in the database 22. The search and retrieve signals Sr may be sent by any manner possible, including through a wired or land connection 41 as illustrated in FIG. 1.

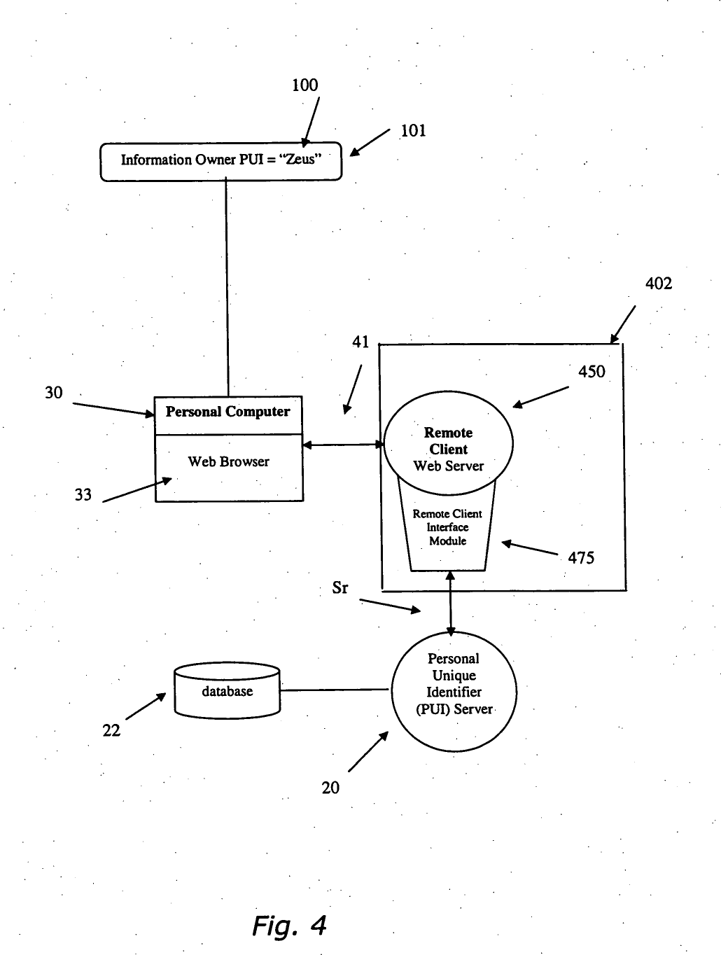

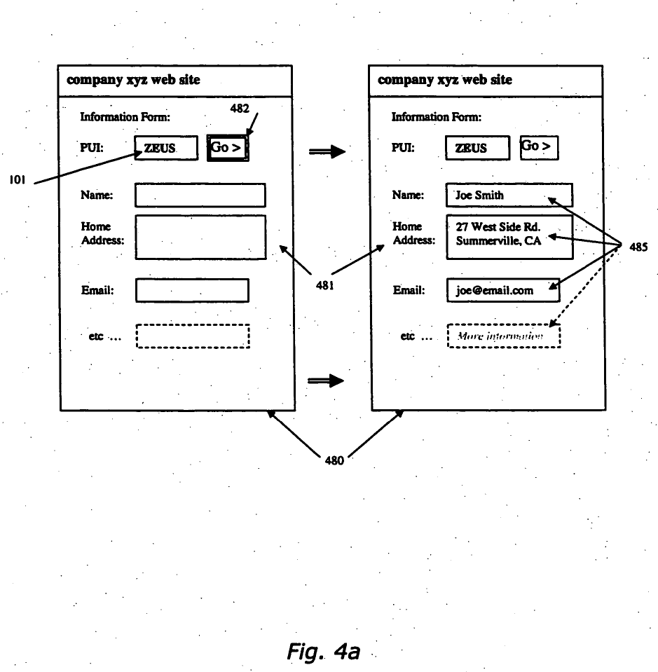

In a preferred embodiment, as illustrated in FIG. 4, the guest 102 may comprise a remote client, identified generally by reference number 402, which may comprise a remote client web server 450. The remote client server may comprise an interface module 475 which facilitates communication with the PUI server 20. The remote client 402 could, for example, be of a nature that routinely accepts and stores people's personal contact information and has also provided a means to accept personal unique identifiers 100 as referenced above. The user 101 may input their personal unique identifier 100 into the remote client web server 450 by way of a personal computer 30 operating a web browser 33. The remote client web server 450 in turn engages the interface module 475 to input the given personal unique identifier 100, along with any other authenticating information which may be required, to the PUI server 20. The PUI server 20, upon authenticating the request from the interface module 475, returns information associated with the given personal unique identifier 100 to the interface module 475. The remote client web server 450 reads the returned information and presents it to the user 101, who in turn can submit it to the remote client web server 450.

FIG. 4a illustrates an example of a user 101 experience as described in the above paragraph. A remote client web server 450 provides the remote client web site 480 having a web form 481 which in this example accommodates contact information shown as name, home address, email, etc. The same web form 481 preferably accommodates a field to enter the personal unique identifier 100 and a means to submit the said personal unique identifier 100 to the remote client web server 450 by way of a button 482. Upon submission of the personal unique identifier 100, and other functionality generally described herein, the web form 481 is populated with contact information 485 associated with the personal unique identifier 100, in this example “Zeus,” which was submitted by way of the submit button 482.

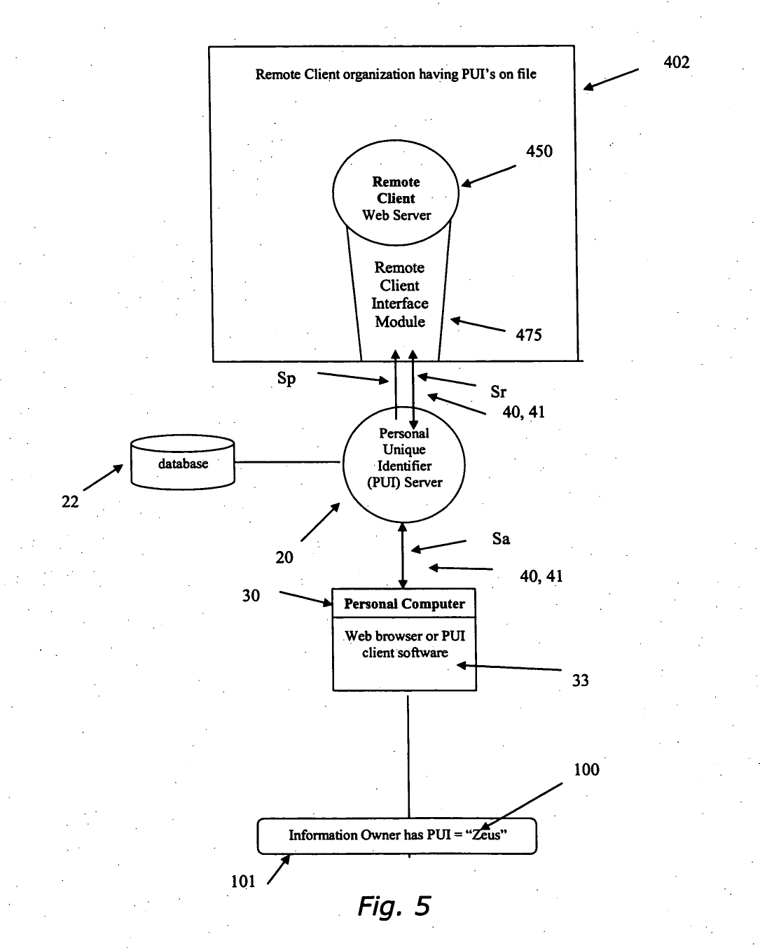

FIG. 5 illustrates a further preferred embodiment where the user 101 may update or add information associated with the user's personal unique identifier 100, which, in this example, is the word “Zeus.” This can be done, for instance, by the user 101 sending add/update signals Sa containing the personal unique identifier 100 uniquely identifying the user 100 together with the updated information regarding the user 101 to the PUI server 20 and the database 22 in any manner, as discussed, for example, above. Update signals Sp containing this updated personal information for particular users 101 can then be sent from the PUI server 20 to the remote client 402 through interface module 475. The remote client 402 may request that update signals Sp containing the updated personal information be sent periodically in a number of ways, examples of which are discussed below.

Independently, a remote client 402, having a digital record of previously given personal unique identifiers 100, can engage its interface module 475 to send search and retrieve signals Sr to and from the PUI server 20 to access information of particular users 101 contained in the database 22 that has been updated. Information can be identified as having been updated in a number of ways, such as by temporarily tracking when changes have been made to the personal information by the particular users 101.

In a further preferred embodiment, the PUI server 20 can track associations between particular users 101 and specific remote clients 402 and simply notify the specific remote clients 402 when a modification has occurred by a particular user 101. An association may be tracked between a particular user 101 and a specific remote client 402 if the particular user 101 uses their personal unique identifier 100 in a web form 480, for example, or the remote client 402 otherwise accesses the personal information of a particular user 101 using the personal unique identifier 100 of the particular user 101. At the option of the remote client organization 402, the PUI server 20, upon receiving updates from the user 101, can in turn send update signals Sp to the interface module 475 of the remote client server 450 if the PUI server 20 has tracked an association between a particular user 101 and a specific remote client 402. These update signals Sp may contain the personal unique identifiers 100 of the user 101, which have updated their personal information and for which the personal unique identifier 100 has tracked, and preferably stored in the database 22, the association with the specific remote client 402. Preferably, the remote client web server 450 may receive these update signals Sp and then decide if they wish to receive the updated personal information of the particular users 101 uniquely identified by the personal unique identifiers 100 contained in the update signal Sp. It is understood that a monetary fee may be charged to the remote client 402 at various stages for the services discussed above. It is also understood that these notifications are merely examples of types of notifications which can occur. Also, these notifications can be prompted either by the PUI server 20 or in response to a search and retrieve signal Sr from a specific remote client 402.

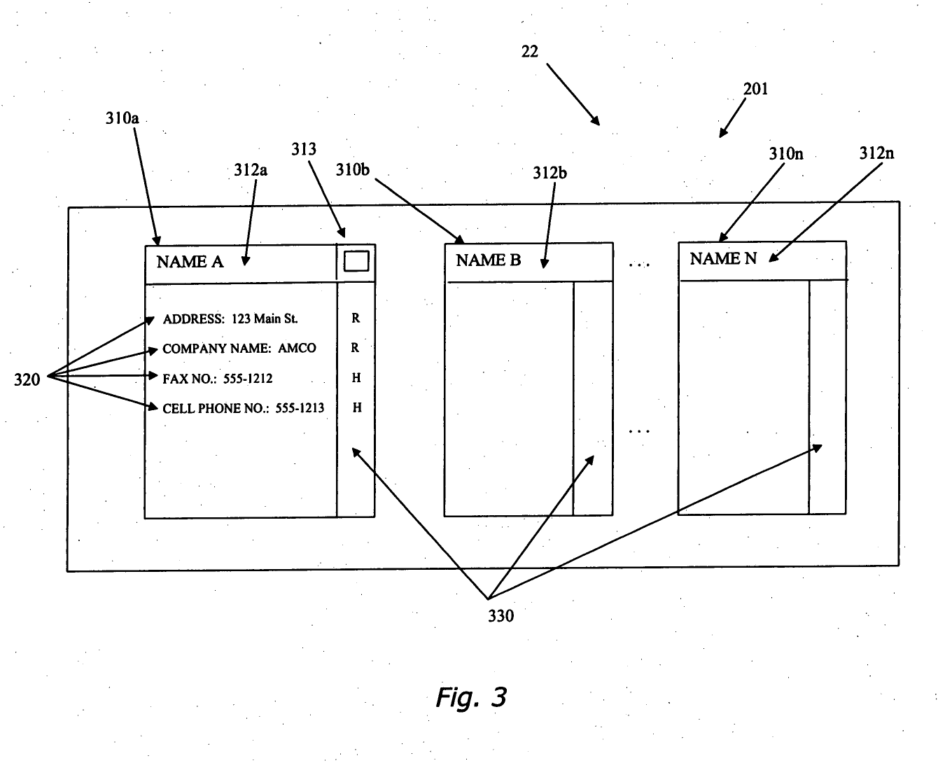

As illustrated in FIG. 3, the database 22 may store personal contact information shown generally by reference numeral 320. In a further preferred embodiment, the database 22 stores personal contact information in different categories, also referred to as cards and illustrated, for instance, in FIG. 3 by reference numeral 310. There may be a number of cards 310, identified for convenience by the specific reference numerals 310a, 310b and 310n. The cards 310 may also have a name, identified generally by reference numerals 312a, 312b, 312n, which identify each of the cards 310 for the easy organization by the user 101. In a preferred embodiment, the names 312 may be altered as the user 101 sees fit.

The cards 310 may each contain different types of personal information. For instance, one card 310a could have company or work information, another card 310b may have home or shipping information and other cards 310n may similarly be organized with information of a different nature.

In a further preferred embodiment, one or more of the components of contact information 320 may also have a reveal/hidden status 330. The reveal/hidden status 330 will be an identification of the privacy level of the associated information. For instance, a reveal/hidden status 330 having a value “R” may constitute information which may be revealed to anyone who accesses the database 22 through a device 30, whether this is done through a website, accessed by a network such as the Internet N, or directly via a device 30. In another embodiment, for each component of contact information 320 which has a reveal/hidden status of H hidden, the associated information may not be visible to guests 102 who access the database 22 unless they have additional information, such as a key 99 as outlined below. In a preferred embodiment, each card 310 has a card reveal/hidden status 313 which permits the user to change the reveal/hidden status 330 of all of the information in the card 313.

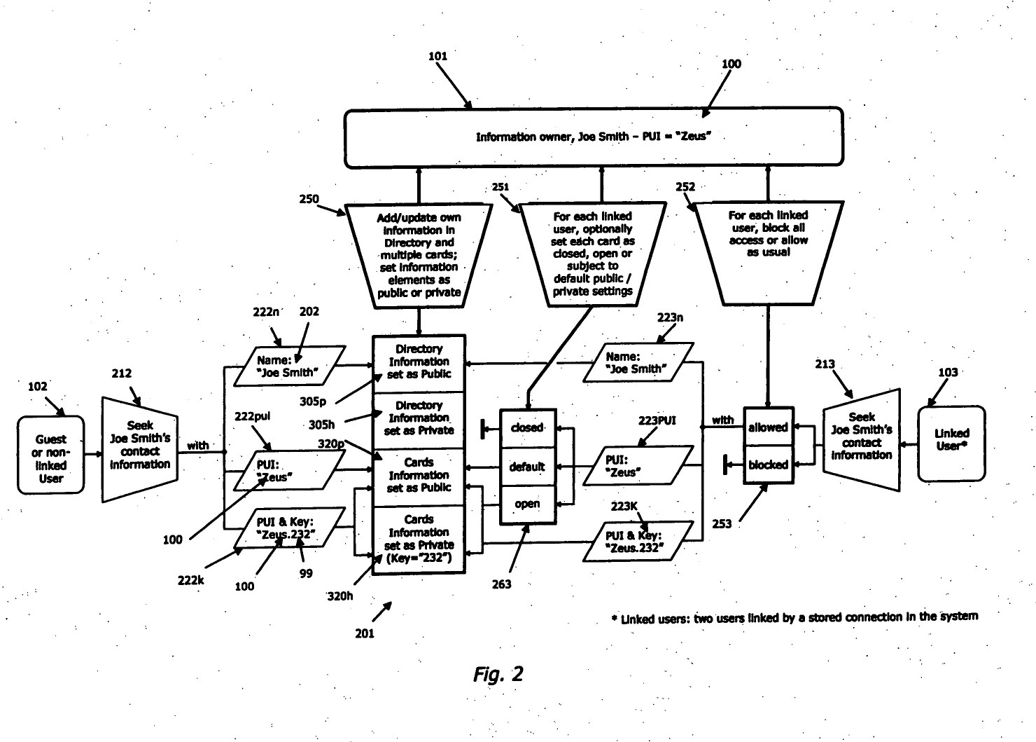

FIG. 2 illustrates additional functionalities of the system and method according to one preferred embodiment of the present invention. As illustrated in FIG. 2, the information owner or user 101, in this case having the personal unique identifier “Zeus,” has the personal name Joe Smith.

The personal user information 201 of the user 101 Joe Smith will be stored in the database 22. In a preferred embodiment, the personal information 201 may be stored as illustrated in FIG. 3 and discussed above. In a further preferred embodiment, the information 201 may be stored as illustrated in FIG. 2 and may comprise contact information 320 set as both public information 320p and hidden information 320h, as was the case with the contact information 320 having the reveal/hidden status 330 shown in FIG. 3. Furthermore, the personal information 201 may also comprise directory information 305. The directory information 305 may comprise name and location information, and, can be set as either public 305p, or private 305. It is understood that these are merely examples of information that can be stored in the directory, and many other types of information may be set as either public or private. In a preferred embodiment, the directory information set as public will include the name of the owner “Joe Smith” to facilitate searching as discussed below.

As illustrated in the step 250, the user 101, in this example being “Joe Smith,” may add or update the user's own information in the directories 305p and 305h as well as in the cards 310. This can be done, for instance,.by the user 101 accessing the PUI server 20, as illustrated by signal Sa in FIG. 1, using the personal unique identifier 100 and another password (not shown) and then accessing the information.

Once the user identified by the personal unique identifier “Zeus” sets the information in the directories 305 and cards 310, third parties, such as guests or other users, shown generally by reference numeral 102, may access the information. For instance, the guest 102 may seek out the contact information for Joe Smith by performing a search, shown in step 212. The search may be initiated, for instance, by the guest 102 sending a search and retrieve signal Sr as illustrated in FIG. 1. The search may be with a number of different parameters including the name of the user 202, in this example “Joe Smith” identified by the search term 222n, the personal unique identifier 100, in this example “Zeus” identified at search term 222pui and/or the personal unique identifier 100 and the key 99 identified at search term 222k. As illustrated in step 222k, the personal unique identifier 100 and the key 99 in this example consists of the alphanumeric code “Zeus.232” comprising the PUI “Zeus” in this example and the key “232” in this example.

It is understood that one or more of the search terms 222 will be received by the PUI server 20 in order to access the personal information 201. For instance, as illustrated in FIG. 2, in one preferred embodiment, the PUI server 20 may permit a guest 102 having merely the name search term 222n to access the directory information set as public 305p. This could be used, for example, similar to a telephone directory providing information as to a person's full name and location, and/or any other information the user chooses to allow the public access to, solely with the name search term 222n. In a further embodiment, a guest 102 may be provided by the PUI server 20 with a means to request more information from the user 101, in a manner that does not reveal any further information about the user 101. Receipt of such requests by the user 101 is at the user's discretion.

If the guest 102 has the personal unique identifier search term 222pui, then the guest 102 may have access to the information set as public 320p. It should be noted that the guest 102 may have the name search term 222n or the personal unique identifier search term 222pui or both. However, different information may be available with these two separate search terms 222n and 222pui. It is also understood that the user 101 would have set the information available by these two separate search terms 222n, 222pui.

Furthermore, using the PUI and key search terms 222k, a guest 102 may access the public card information 320p as well as the hidden card information 320h. It is understood that the PUI and key search term 222k may be provided so that a user may give their personal unique identifier 100 to several individuals but only have the key 99, which is normally kept confidential, given to certain guests 102. Furthermore, while not illustrated in FIG. 2, in a further preferred embodiment it is possible to have different keys 99 associated with the same personal unique identifier 100. For instance, the same personal unique identifier “Zeus” may have a key 99, such as the alphanumeric code “232” illustrated in FIG. 2 for some guests 102 providing access to some information set as private 320h, and may provide other keys 99 consisting of other alphanumeric codes to other guests 102 to provide access to other card information set as private (not shown). This could be done to permit the user 101 to give access to different personal information 201 to different guests 102.

In addition to the functionality discussed above with respect to the guest or other persons 102, the present system 10 in a preferred embodiment also facilitates special access to linked users (whether individuals or organizations), shown generally by reference numeral 103. Linked users 103 may comprise any user of the system 10 which has been linked by any type of stored connection in the system 10 to another user. Such a stored connection could result for instance if a user is also a member of the same system 10. Such a stored connection could also result in the narrower situation where two users have both placed personal information 201 in database 22 and also have accessed each other's personal information. In either case, a guest 102 can be transformed to the status of linked user 103, and the linked user 103 will also be able to perform a search step as shown in step 213. There is also a separate functionality shown in step 252 whereby a particular user can set a linked user 103 as allowed, where the linked user 103 is allowed access to the personal information 201, or blocked, where the linked user 103 is not allowed access, as illustrated in the allowed/blocked step 253. In the case, where the access is allowed at the allowed/blocked step 253, the linked user 103 will be provided access to the personal information 201 of the user 101 in the normal course. However, if access is blocked at allowed/blocked step 253, the linked user 103 would be denied access to the information. This denial of access may result, for example, by simply indicating that that particular information is no longer available. This denial of access may also trigger a demand that the requesting linked user 103 delete any copies of the personal information of user 101, that the linked user 103 may have previously acquired. This can be accomplished, for instance, because the linked user 103 will be identified within the system 10.

If access to a linked user 103 is allowed in step 253, the linked user 103 may then search the database 22 using different parameters including the search terms 223. These search terms 223 may comprise the name search term 223n, the personal unique identifier search term 223PUI, and the personal unique identifier and the key search term 223k. The name search term 223n, the personal unique identifier search term 223PUI and the PUI and key search terms 223k would be performed in a similar manner to the name search terms 222n, the personal unique identifier search term 223PUI and the PUI and key search terms 222k discussed above with respect to a guest or other non-linked user 102. However, by means of the function 251, the user 101 is permitted the flexibility to optionally set cards as open, closed, or subject to a default public/private setting for particular linked users 103. In this way, if the user 101 has not yet given a key 99 to the linked user 103, the user 101 may still permit the linked user 103 access to both the information set as public 320p and the information set as private 320h through the open option at step 263. Furthermore, step 263 also provides a close function whereby access by a linked user 103, who has nevertheless been allowed access at step 253, can still be denied or closed access to the personal information 201 at step 263.

As is apparent from the above, a guest or other person 102, having the personal unique identifier 100, for a particular user 101, can easily and continuously access personal information 201 about the particular user 101. This is the case whether or not any personal information 201 regarding the user 101 has remained permanent or has changed. Furthermore, the user 101 has the option of what information 202 a particular guest 102 can be granted access to depending on whether or not the user 101 has given merely the personal unique identifier 100 and/or a key 99 and/or a different key (not shown). In this way, a particular user 101 can control the specific personal information 201 which is revealed or hidden.

In the further preferred embodiment, in cases where guests or other persons 102 access information about a particular user 101 using the name search term 222n, the guest 102 may contact the user 101 such as by sending an e-mail or other type of message which the user 101 may or may not wish to respond to. Furthermore, access to the user 101 using a name search 222n, or any other search term other than the personal unique identifier 110, with or without a key 99, could be denied at the user's 101 sole discretion. In this way, the user 101 can grant access to all guests 102 merely with the guest knowing the user's 101 name, or, may only grant access to information 201 to guests 102 who have at least the personal unique identifier 100. In this way, the user 101 has different options for how to grant access to personal information 201. It is also apparent that the guests 102 can access information regarding a user 101, whether or not the guest 102 is also a user of the system 10. In other words, the system 10 facilitates access to information by guests 102 who are in essence members of the public and does not require them to also become users of the system 100 to be able to access the personal information 201 of a user 101.

It is understood that the description above with respect to FIG. 2 is one preferred embodiment of the present invention and is intended to describe different functions of the invention rather than to limit the invention to these specific features. It is also understood that these specific features can be used in combination with other features that have not been described but are known to persons skilled in the art without deviating from the present invention.

It is also understood that reference to user 101 herein is not limited to an individual, but rather is intended to include any organization, entity or group. Similarly, it is understood that reference to guest or other person is not limited to an individual, but rather is intended to include any organization, entity or group, including without limiting the foregoing, a remote client 402.

To the extent that a patentee may act as its own lexicographer under applicable law, it is hereby further directed that all words appearing in the claims section, except for the above defined words, shall take on their ordinary, plain and accustomed meanings (as generally evidenced, inter alia, by dictionaries and/or technical lexicons), and shall not be considered to be specially defined in this specification. Notwithstanding this limitation on the inference of “special definitions,” the specification may be used to evidence the appropriate ordinary, plain and accustomed meanings (as generally evidenced, inter alia, by dictionaries and/or technical lexicons), in the situation where a word or term used in the claims has more than one pre-established meaning and the specification is helpful in choosing between the alternatives.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments, which are functional, electrical or mechanical equivalents of the specific embodiments and features that have been described and illustrated herein.

What is claimed:

1. A method for granting access to personal information of said first person, said method comprising:
said first person selecting a personal unique identifier to uniquely identify said first person in a database;
storing the personal information of the first person in association with personal unique identifier of the person in the database;
providing the personal unique identifier of the first person to a second person; and
said second person submitting the personal unique identifier into the database to retrieve said personal information of the first person.

2. A method for facilitating access to personal information, said method comprising:
selecting a personal unique identifier to uniquely identify a user in a database controlled by a personal unique identifier server;
storing personal information regarding the user in the database associated with the personal unique identifier;
providing the unique identifier to at least one other person, other than the user; and
the at least one person submitting the unique identifier to the personal unique identifier server to access the personal information associated with the personal unique identifier stored in the database, said personal information reflecting personal information submitted by the user.

3. The method of claim 2, comprising:
said user storing a user password different from the unique identifier of the user when said user stores information regarding the user in the database in association with the personal unique identifier; and
said user periodically accessing the personal unique identifier server by submitting the personal unique identifier and the user password to the personal unique identifier server to modify the personal information;
wherein said at least one person submitting the unique identifier to the personal unique identifier server to access the personal information associated with the personal unique identifier accesses the personal information updated by the user.

4. The method as defined in claim 2, wherein said at least one other person comprises a remote client, and said method further comprising:
providing, by the user to the remote client, the personal unique identifier uniquely identifying the user; and
submitting, by the remote client to the personal unique identifier server, the personal unique identifier uniquely identifying the user to access the personal information of the user.

5. The method as defined in claim 4, further comprising:
providing the user's personal unique identifier to the remote client by the user submitting the personal unique identifier on a web form hosted by the remote client; and
populating the web form, by the remote client, with the personal information accessed by the remote client from the personal unique identifier server.

6. The method as defined in claim 5, further comprising:
accepting, by the user, the information populated on the web form if the personal information is acceptable to the user.

7. The method as defined in claim 3, wherein said at least one other person comprises a remote client having a remote server, said method further comprising:
said remote server periodically sending search and retrieve signals to the personal unique identifier server, said search and retrieve signals having the personal unique identifier of the user attached thereto;
searching, upon receipt of the search and retrieve signals by said unique identifier server, the database for updates made by the user identified by the personal unique identifier; and
sending, by the personal unique identifier server to the remote server, any updates made by the user identified by the personal unique identifier.

8. The method as defined in claim 3, wherein said at least one other person comprises a remote client having a remote server, said remote client having previously accessed personal information regarding the user using the personal unique identifier uniquely identifying the user, said method comprising:
storing, in the database, by said personal unique identifier server, an indication that the remote client has previously accessed the personal information regarding the user using the personal unique identifier uniquely identifying the user; and
sending an update signal from said personal unique identifier server to the remote server when the user modifies the personal information associated with the personal unique identifier uniquely identifying the user.

9. A system for controlling access to personal information, said system comprising:
a database containing a plurality of personal unique identifiers, each personal unique identifier uniquely identifying personal information of a particular user associated with the corresponding unique personal identifier; and
a personal unique identifier server for providing access to the personal information stored in the database;
wherein the user can provide their personal unique identifier to at least one person, other than the user, such that said at least one other person can access the personal information of the user associated with the unique personal identifier through the personal unique identifier server.

10. The system as defined in claim 9, further comprising:
a network through which the personal unique identifier and personal information can be sent and received to and from the personal unique identifier server; and
wherein the user and said at least one other person can access the personal unique identifier server through the network.

11. The system as defined in claim 9, wherein the user can segregate the personal information stored in the database into hidden and revealed information, wherein the hidden information is associated with a further key identifier; and
wherein the user provides said at least one person with the unique personal identifier and the key identifier to access the hidden information.

12. The system as defined in claim 9, wherein the user inputs the personal unique identifier and a further password identifier to the personal unique identifier server, to make modifications to personal information associated with the personal unique identifier uniquely identifying the user.

13. The system as defined in claim 9, wherein said at least one other person comprises a remote client having a remote server; and
wherein the remote server submits personal unique identifiers of particular users to the personal unique identifier server to obtain access to personal information of the particular users uniquely identified by the personal unique identifiers.

14. The system as defined in claim 9, wherein said at least one other person comprises a remote client having a remote server, said remote server hosting an electronic form accessible by the particular users;
wherein said electronic form comprises a field for submission of personal unique identifiers; and
wherein the remote server accesses, through the personal unique identifier server, the personal information contained in the database of a corresponding user uniquely identified by the personal unique identifier submitted in said electronic form, and, said remote server populates the electronic form with the personal information of the corresponding user accessed by the remote client from the database through the personal unique identifier server.

15. The system as defined in claim 14, further comprising:
an interface module associated with the remote server for sending a search and retrieve signal to the personal unique identifier server upon submission of the personal unique identifiers uniquely identifying the corresponding user, and, for receiving the personal information from the personal unique identifier server.

16. The system as defined in claim 15, further comprising:
a network through which the personal unique identifier and personal information can be sent and received to and from the personal unique identifier server and remote server; and
wherein the users and the interface module associated with the remote server can access the personal unique identifier server through the network.

17. The system as defined in claim 16, wherein the interface module periodically sends the search and retrieve signals containing personal unique identifiers regarding the corresponding users to the personal unique identifier server; and
wherein, in response to the search and request signal, the personal unique identifier server searches the database for updates made by the corresponding users identified by the personal unique identifiers contained in the search and retrieve signals and provides the updated personal information to the interface module through the network.

18. The system as defined in claim 16, wherein the database contains an indication that the remote client has accessed the personal information regarding the corresponding user; and
wherein, when the corresponding user updates their personal information, the personal unique identifier server sends an update signal to the interface module of the remote client indicating that an update has occurred.

19. The system as defined in claim 16, wherein the network is the Internet and the electronic form is a web form hosted on a web page by the remote server.
